(19) United States
(12) Patent Application Publication
(10) Pub. No.: US 2006/0286241 A1
(43) Pub. Date: Dec. 21, 2006

(54) Edible moisture barrier compositions and methods for preparation thereof

(76) Inventor: Thomas Krinski, Granite City, IL (US)

Correspondence Address: SOLAE, LLC, PO BOX 88940, ST LOUIS, MO, 63188, US

(21) Appl. No.: 11/145,914

(22) Filed: Jun. 6, 2005

(51) Int. Cl. A21D 13/00

(52) U.S. Cl. 426/549

(57) ABSTRACT

Disclosed is a novel edible moisture barrier composition comprising a soy protein component. The edible composition is suitable for application to one or more layers of a food product and is capable of minimizing moisture migration between these layers over an extended period of time. Additionally, the edible composition can be applied to an outer layer of a food product to reduce moisture migration from the product to the surrounding environment. Also disclosed are methods for preparing the edible moisture barrier composition.

### BACKGROUND OF THE INVENTION

The present invention generally relates to an edible moisture barrier composition. More particularly, the present invention relates to an edible moisture barrier composition comprising a soy protein that when applied to a food product, minimizes moisture migration between independent layers in the food product or between a food product and the ambient environment.

Consumers have come to expect convenient, high quality food products. For many prepackaged food products, varying moisture levels must be maintained within distinct regions of the product in order to provide pleasing organoleptic properties, such as texture, firmness, crispness, quality and taste. Moisture migration, either within distinct layers of the food product or between the food product and the packaging or storage environment, can negatively affect the food's organoleptic properties and, thus, the consumer's sensory experience.

In multi-component food products, particularly those having distinct components or layers with different moisture contents and water activities (e.g., pizzas, potpies, glazed doughnuts, fruit or cream pies, prepackaged cheese and crackers or prepackaged bagel and cream cheese products), moisture can migrate between adjacent components or layers altering the component's or layer's characteristics and organoleptic properties. Another problem caused by moisture migration is storage stability, which can hinder production and distribution of food products. For example, the sauce of a pizza can dry out while, at the same time, the pizza crust can lose its crispness as moisture migrates from the sauce to the crust.

One method to prevent moisture migration in foods involves coating one or more surfaces of the food product with an edible moisture barrier composition. Such barriers are characterized as having a low moisture permeability to prevent the migration of water between areas of differing water activities. In addition, the edible moisture barrier composition should provide a substantially continuous layer, while adhering well to the food product's surface. Also, the edible moisture barrier composition should form a flexible layer, be easily penetrated during consumption and have a taste, aftertaste, and mouth feel such that the consumer is not aware of the moisture barrier when the food product is consumed.

### SUMMARY OF THE INVENTION

The present invention includes a soy protein-containing edible moisture barrier composition that can be utilized in food products having distinct layers, which comprise different levels of moisture. In one embodiment, the composition is introduced between a first layer and a second layer of a food product wherein the water activity of the second layer is at least about 0.05 different than the water activity of the first layer. Once applied, the composition substantially reduces the migration of moisture from the moisture-rich layer to the moisture-reduced layer. Additionally, the edible moisture barrier compositions can also be used to reduce moisture transfer from a food layer or product to the ambient environment. Also, the present invention includes processes for making the edible soy protein compositions of the present invention.

In one embodiment, an edible moisture barrier composition for minimizing moisture migration from a first layer to a second layer in a food product comprises an edible amphoteric carrier component capable of immobilizing the edible moisture barrier composition on either the first or second layer, wherein the edible amphoteric carrier is substantially soluble in water. In addition, the composition comprises an edible hydrophobic component capable of coalescing at an application temperature; and an edible dispersing agent capable of increasing the dispersal of the edible hydrophobic component in the edible amphoteric carrier.

In another embodiment, a food product comprises a first layer, a second layer, and an edible moisture barrier composition located between the first layer and second layer. The edible moisture barrier composition comprises an edible amphoteric carrier component capable of immobilizing the edible moisture barrier composition on either the first or second layer, wherein the edible amphoteric carrier is substantially soluble in water. The composition also comprises an edible hydrophobic component capable of coalescing at an application temperature; and an edible dispersing agent capable of increasing the dispersal of the edible hydrophobic component in the edible amphoteric carrier.

In yet another embodiment, an edible moisture barrier composition for minimizing moisture migration from a first layer to a second layer in a food product comprises a soy protein component capable of immobilizing the edible moisture barrier composition on either the first or second layer, wherein the soy protein is substantially soluble in water. The composition further comprises a soybean oil component; a lecithin capable of increasing the dispersal of the soybean oil in the soy protein; and a gum capable of promoting the immobilization of the edible moisture barrier composition.

In a further embodiment, a process for preparing a food product containing an edible moisture barrier layer to minimize moisture migration from a first layer to a second layer in the food product comprises forming a carrier-hydrocolloid mixture by mixing an edible amphoteric carrier component capable of immobilizing the edible moisture barrier composition on either the first or second layer, wherein the edible amphoteric carrier is substantially soluble in water, with an edible hydrocolloid component capable of aiding the carrier gel formation. The process further comprises forming a hydrophobic component-dispersing agent mixture by mixing an edible hydrophobic component capable of coalescing at an application temperature with an edible dispersing agent capable of aiding dispersal of the edible hydrophobic component in the carrier. Also, the process comprises forming a moisture barrier composition by spraying the hydrophobic component-dispersing agent mixture into the carrier-hydrocolloid mixture; and forming a moisture barrier layer by spraying the moisture barrier composition onto a food layer of the food product to minimize moisture migration within the food product or onto an outer surface of the food product to minimize moisture migration of the food product with the ambient environment.

### DETAILED DESCRIPTION

Among the various aspects of the present invention is an edible moisture barrier composition for minimizing moisture migration between distinct layers in a food product and between the food product and the ambient environment. Moisture migration in a food product can cause degradation of the quality of the food product by making a layer with a lower moisture content soggy, while at the same time drying out a layer with a higher moisture content. The edible moisture barrier of the composition has the following characteristics: (1) it effectively minimizes moisture migration between layers in a food product, (2) it provides a substantially continuous barrier between food layers, (3) it is chemically and physically storage stable, and (4) it has a substantially imperceptible taste and appearance.

Edible Moisture Barrier Composition

Generally, to fulfill the above characteristics, the edible moisture barrier composition combines a variety of components, which when taken together provide advantageous properties. The edible moisture barrier composition of the present invention includes an edible amphoteric carrier component capable of immobilizing the edible moisture barrier composition on either the first or second layer, wherein the edible amphoteric carrier is substantially soluble in water. The composition further includes an edible hydrophobic component capable of coalescing at an application temperature. Also, the composition includes an edible dispersing agent capable of increasing the dispersal of the edible hydrophobic component in the edible amphoteric carrier. In some embodiments, the composition may optionally include an edible hydrocolloid component capable of promoting the immobilization of the edible moisture barrier composition. The hydrophobicity of the edible hydrophobic component causes the immobilized moisture barrier composition to be repelled by each water-containing food layer wherein the combination of the edible, hydrophobic component and edible dispersing agent is the actual barrier to water migration between a first layer and a second layer in the food product.

The edible moisture barrier composition of the present invention is preferably used for food products with multiple distinct layers, wherein the layers have different water activities and wherein it is desirable to minimize or eliminate the transfer of water from one layer to the other. Water in food products that is not bound to food molecules can support the growth of bacteria, yeasts, and moulds. As used herein, the term “water activity” refers to this unbound water. As would be recognized by one skilled in the art, the water activity of a food product is not the same as the moisture content of a food product. Although moist foods are likely to have greater water activity than dry foods, this is not always true. Many food products may have the same moisture content yet have different water activities.

The water activity scale for a food product is from 0 (bone dry) to 1.0 (pure water). But most food products have a water activity level in the range of 0.2 for very dry foods to 0.99 for moist fresh foods. Water activity represents the ratio of the water vapor pressure of the food product to the water vapor pressure of pure water under the same conditions and is expressed as a fraction. Of course, different layers within a single food product may have different water activities.

Advantageously, the edible moisture barrier composition described herein may be applied between distinct layers having different water activities in the food product prior to storage (e.g., packaged and refrigerated or frozen). Thus, the edible moisture barrier composition mninimizes the migration of water between layers with different water activities upon storage of the food product. Generally, the edible moisture barrier composition is applied when a first and second layer have a difference in water activity of at least about 0.1, or 0.2, or 0.3, or 0.4, or even 0.5 or greater.

Alternatively, the edible moisture barrier composition could be applied to an outer surface of a food product to prevent water migration between the food product and the packaging or between the food product and the outside environment.

Another of the various aspects of the present invention is a method of preparing an edible moisture barrier composition of the invention. This method is described in more detail herein below.

In the following sections, the components of the edible moisture barrier composition of the invention are described in more detail.

Amphoteric Carrier Component

The edible moisture barrier composition of the present invention comprises an edible amphoteric carrier component capable of immobilizing the edible moisture barrier composition on a product. The edible amphoteric carrier component is substantially soluble in water. The carrier is amphoteric; that is, the carrier can act as an acid or as a base. Stated another way, the amphoteric carrier as either an acid or a base can react with a base or an acid. Furthermore, the amphoteric carrier contains hydrophobic and hydrophilic groups. Accordingly, the amphoteric carrier has sufficient hydrophilic character to be substantially soluble in water at a pH of about 6 to about 8 and it has sufficient hydrophobic character to disperse the hydrophobic component of the composition of the present invention. Furthermore, the amphoteric carrier component comprises polar portions, which are able to chemically interact with water to be substantially soluble at a pH of about 6 to about 8 and nonpolar portions, which are able to chemically interact with the edible hydrophobic component of the composition of the present invention. This combination of polar and nonpolar functionality for the amphoteric carrier is a characteristic possessed by the exemplary amphoteric carrier components discussed herein below.

As noted above, the edible amphoteric carrier component is substantially soluble in water at a pH of about 6 to about 8 (pH measured for a 5 wt. % aqueous solution) at room temperature. Substantial solubility of the edible amphoteric carrier component in water means that the carrier has a solubility of from about 4 to about 18 wt. % in water at a pH of about 6 to about 8 and at room temperature, and preferably from about 5 to about 15 wt. %. In particular, for soy proteins, the nitrogen solubility index (NSI), which provides a measure of the percent of water-soluble protein relative to the total protein in a protein-containing material, directly relates to the water solubility for soy proteins. A low NSI indicates protein denaturation, which is indicative of low solubility. The NSI for the exemplary soy proteins used as edible amphoteric carriers, as described herein below, are from about 85% to about 90% or more. A method to determine the nitrogen solubility index is A.O.C.S. Method Ba 11-65, well known to those skilled in the art.

Exemplary edible amphoteric carrier components include surfactants, starches, proteins and the like. A presently preferred edible amphoteric carrier component comprises a high viscosity and medium/high gelling soy protein. High viscosity soy proteins have a viscosity (measured at 10 to 16 wt. % solids) of at least about 200 cp and suitably at least about 1,000 cp, 2,000 cp, 3,000 cp, 4,000 cp or more. These viscosities are measured at up to about 16 wt. % solids at 60 rpm and 25° C. The maximum viscosity of soy proteins suitable for use is 20,000 cp at 60 rpm and 25° C. The viscosity of the soy proteins is directly related to the gelling capability of the soy protein, thus typically, a soy protein having a high viscosity will also be a medium/high gelling soy protein. The property of high viscosity allows the edible amphoteric carrier to gelatinize upon contact with moisture in the food product and thus, immobilize the edible moisture barrier between the food layers. However, the soy protein does not absorb a substantial amount of moisture, as the soy protein should not disturb the moisture balance between the layers in the food product.

Suitable sources of high viscosity and/or medium/high gelling isolated soy protein (i.e., unhydrolyzed) for use as the amphoteric carrier component have a viscosity of about 200 to about 4,000 cp at 60 rpm and 25° C., a particle average diameter of about 60 to about 80 microns, a gel strength of greater than about 1500 grams for a sample having a 6:1 water to protein ratio, and a water holding capacity of greater than about 6 grams water per gram protein. Exemplary soy proteins include SUPRO 620, SUPRO 760, SUPRO EX33 and FXP H0120 available from The Solae Company (St. Louis, Mo.); PROFAM 981 available from Archer Daniels Midland (Decatur, Ill.); and PROLISSE soy protein isolate available from Cargill Soy Protein Solutions, Inc. (Minneapolis, Minn.). In a presently preferred embodiment, the edible amphoteric carrier component is selected from the group consisting of SUPRO 620, SUPRO 760, SUPRO EX33 and FXP H0120 available from The Solae Company (St. Louis, Mo.), and combinations thereof. More preferably, the edible amphoteric carrier component is selected from the group consisting of SUPRO EX33 and FXP H0120 available from The Solae Company (St. Louis, Mo.), and combinations thereof.

Accordingly, the viscosity of the soy protein, as well as the thickness of the moisture barrier composition between food layers, as discussed below, is selected to minimize the disturbance of the moisture balance between layers in the food product. Upon preparation of the food product (e.g. baking, cooking, heating, toasting, etc.), the edible amphoteric carrier will release moisture to the food product, and thus, not substantially affect the water activity in each layer of the final product.

Generally, high viscosity and/or medium/high gelling isolated soy proteins have greater molecular weights than soy proteins with lower viscosity and gelling. Table 1 provides molecular weight distributions for certain of the commercial SUPRO® products mentioned above.

TABLE 1
Estimated Molecular Weight Distribution of SUPRO products determined
at an absorbance of 280 am using HPLC-SEC (High Performance Liquid
Chromatography—Size Exclusion Chromatography) gel filtration
in 6M guanidine HCl.

| Product | >50,000 | 20,000-50,000 | 5000-20,000 | 2000-5000 |
|---|---|---|---|---|
| SUPRO ® 620 | 21% | 44% | 30% | 5% |
| SUPRO ® 760 | <10% | 40% | 40% | 12% |
| SUPRO ® EX33 | 41% | 31% | 25% | 3% |
| FXP H0120 | 15% | 36% | 38% | 7% |

The particle size distribution of the particular soy proteins is selected so that the particles are small enough to be spray dried and to provide a thin, uniform edible moisture barrier layer on the food product. Furthermore, the particle size distribution is relatively narrow (average diameter of about 60 to about 80 microns) to facilitate the uniform distribution of the edible hydrophobic component and the dispersing agent within the edible amphoteric carrier component.

In one embodiment, the edible amphoteric carrier component (e.g., soy protein), is present in the edible moisture barrier composition at a concentration from about 75% (by weight edible moisture barrier composition) to about 98.5% (by weight edible moisture barrier composition); preferably, the concentration is from about 75% (by weight edible moisture barrier composition) to about 97% (by weight edible moisture barrier composition); even more preferably, the concentration is from about 95% (by weight edible moisture barrier composition) to about 97% (by weight edible moisture barrier composition).

Hydrophobic Component

As described herein above, the carrier component of the edible moisture barrier composition of the invention generally is capable of immobilizing a hydrophobic component, wherein the hydrophobic component is capable of minimizing moisture migration. Exemplary hydrophobic components are fats and oils having a melting point of about 25° C. or lower, or even 20° C. or lower. The hydrophobic component is capable of coalescing at the application temperature of, for example, about 20° C. to form a continuous hydrophobic layer within the edible moisture barrier composition. In order for the hydrophobic component to coalesce, the physical properties of this component are such that particles of the hydrophobic component are able to move toward one another (and away from moisture containing food layers) and form a continuous layer of the hydrophobic component within the carrier component. The coalescence of the hydrophobic component to form a continuous layer allows the edible moisture barrier composition to minimize moisture migration as the continuous hydrophobic layer blocks the water from migrating from a first food layer to a second food layer across the edible moisture barrier composition.

Generally, the hydrophobic component is a liquid or semi-liquid (e.g., oil) at the application temperature. The application temperature is the temperature at which the edible moisture barrier composition is applied to a food product; for example, the application temperatures may range from about 10° C. to about 50° C., depending upon the specific food product to which the composition is being applied. Preferably, the hydrophobic component is an oil. Exemplary oils are vegetable oils such as soybean oil, canola oil, safflower oil, palm oil, rapeseed oil, sunflower oil, peanut oil, cottonseed oil, palm kernel oil, olive oil, coconut oil, grape seed oil, flax oil, linseed oil, mustard oil, sesame oil, corn oil and the like and combinations thereof. A presently preferred oil is a refined soybean oil.

In one embodiment, the hydrophobic component is present in the edible moisture barrier composition at a concentration of from about 1 wt. % to about 9 wt. %; preferably, the concentration is from about 2 wt. % to about 5 wt. %; more preferably, the concentration is from about 2 wt. % to about 4 wt. %. A presently preferred concentration of the hydrophobic component is about 3 wt. %.

Dispersing Agent

The edible dispersing agent increases the dispersal of the edible hydrophobic component in the edible amphoteric carrier component. Stated another way, the dispersing agent promotes the uniform mixing of the edible, hydrophobic component in the edible amphoteric carrier so the aggregation of particles of the edible, hydrophobic component is minimized. Generally, the dispersing agent is an edible emulsifier such as monoglycerides, diglycerides, lecithins and the like. A preferred edible dispersing agent comprises lecithin. The lecithin can be from a variety of sources. A presently preferred lecithin is soy lecithin having an acetone insoluble fraction of from about 50% to about 54%; an acid value of about 32; a heavy metals concentration of less than about 40 ppm; a Gardner color value of less than about 14; and a viscosity of about 10 to about 15 centipoise.

In one embodiment, the edible dispersing agent is present in the edible moisture barrier composition in a concentration from about 0.05% (by weight edible moisture barrier composition) to about 2.7% (by weight edible moisture barrier composition) or about 5-30 wt. % of the hydrophobic component. Preferably, the concentration of the edible dispersing agent is from about 0.1% (by weight edible moisture barrier composition) to about 0.9% (by weight edible moisture barrier composition) and preferably from about 0.2% (by weight edible moisture barrier composition) to about 0.4% (by weight edible moisture barrier composition). A preferred concentration of the edible dispersing agent in the edible moisture barrier composition is about 0.3% (by weight edible moisture barrier composition).

Hydrocolloid Component

Optionally, an edible, hydrocolloid component may be added to the moisture barrier composition. A hydrocolloid is a substance that forms a gel in water. The edible, hydrocolloid component promotes the further immobilization of the edible moisture barrier composition by forming a gel upon contact with water in the food product. By appropriate selection of the type and amount of the edible amphoteric carrier component along with the type and amount of the edible hydrocolloid component, if used, the viscosity of the edible moisture barrier composition can be altered to use a wider variety of edible amphoteric carriers.

The edible hydrocolloid component is a high viscosity substance. Exemplary edible hydrocolloid components are high viscosity gums. For example, native guar gum can be used as the edible hydrocolloid component and native guar gum has a viscosity of 5000 cp at 25° C. in a 1 wt. % solution at 60 rpm. Furthermore, carrageenan and xanthan gums can also be used as the edible hydrocolloid component.

In one embodiment, the concentration of the edible hydrocolloid component, when employed, is from about 0.1% (by weight edible moisture barrier composition) to about 2% (by weight edible moisture barrier composition); more preferably, the concentration of the edible hydrocolloid component is from about 0.1% (by weight edible moisture barrier composition) to about 0.5% (edible moisture barrier composition); more preferably, the concentration of the edible hydrocolloid component is from about 0.1% (by weight edible moisture barrier composition) to about 0.2% (by weight edible moisture barrier composition); more particularly; the concentration of the edible hydrocolloid component is about 0.1% (by weight edible moisture barrier composition).

Moisture Barrier Composition Embodiments

Among some of the contemplated embodiments of the moisture barrier composition of the present invention are the combinations of components set forth below in Table 2, wherein all the components are edible. Each component in the boxes without solids lines separating them may be present in any combination, including combinations thereof. Furthermore, the relative amounts of components listed at the bottom of the table apply to any of the combinations listed above.

TABLE 2

| | Hydrophobic | | | |
|---|---|---|---|---|
| Amphoteric carrier | component | Dispersing agent | Hydrocolloid | Flow Modifier |
| starch | soybean oil | monoglyceride | | |
| high viscosity soy | canola oil | diglyceride | | |
| protein peanut oil | | lecithin | | |
| SUPRO 620 | | soy lecithin | | |
| SUPRO 760 | | | | |
| SUPRO EX33 | | | | |
| FXP H0120 | | | | |
| PROFAM 981 | | | | |
| PROLISSE | | | | |
| starch | soybean oil | monoglyceride | guar gum | Precipitated silica |
| high viscosity soy | canola oil | diglyceride | carrageenan gum | Fumed silica |
| proteinpeanut oil | | lecithin | xanthan gum | |
| SUPRO 620 | | soy lecithin | | |
| SUPRO 760 | | | | |
| SUPRO EX33 | | | | |
| FXP H0120 | | | | |
| PROFAM | 981 | | | |
| PROLISSE | | | | |
| 75-98.5 wt.% | 1-9 wt. % | 0.05-2.7 wt. % | | 0.05-0.3 wt. % |
| 75-97 wt.% | 1-5 wt. % | 0.1-0.9 wt. % | | |
| 95-97 wt.% | 2-4 wt. % | 0.2-0.4 wt. % | | |
| | 3 wt.% | 0.3 wt. % | | |
| 75-99.7 wt.% | 1-9 wt. % | 0.05-2.7 wt. % | 0.1-2 wt. % | |
| 75-97 wt. % | 1-5 wt. % | 0.1-0.9 wt. % | 0.1-0.5 wt. % | |
| 95-97 wt. % | 2-4 wt. % | 0.2-0.4 wt. % | 0.1-0.2 wt. % | |
| | 3 wt.% | 0.3 wt. % | 0.1 wt. % | |

B. Method of Preparation of an Edible Moisture Barrier Composition

The method of preparing an edible moisture barrier composition comprises forming a carrier-hydrocolloid mixture by combining an edible amphoteric carrier component that is substantially soluble in water and capable of immobilizing the edible moisture barrier composition when applied to a food product containing moisture, and an edible hydrocolloid component, if used. If an edible hydrocolloid component is not used, the hydrophobic component-dispersing agent mixture is sprayed into the edible amphoteric carrier rather than the carrier-hydrocolloid mixture. Furthermore, a hydrophobic component-dispersing agent mixture is formed by mixing an edible hydrophobic component capable of coalescing at an application temperature with an edible dispersing agent capable of increasing the dispersal of the edible hydrophobic component in the edible amphoteric carrier component. The hydrophobic component-dispersing agent mixture is sprayed into the carrier-hydrocolloid mixture or if there is not a hydrocolloid component in the edible moisture barrier composition, the hydrophobic component-dispersing agent mixture is sprayed into the edible amphoteric carrier component.

In one exemplary embodiment, the amphoteric carrier (e.g., spray dried soy protein base product) is added to a container (e.g., blender). In another container (e.g., blender), the hydrophobic component (e.g., oil) and dispersing agent are mixed or the two components may be otherwise premixed prior to use. Then, the hydrophobic oil-dispersing agent mixture is heated sufficiently to form a liquid and a required amount of the mixture is sprayed into the amphoteric carrier while the carrier is being blended. After about 15 to about 30 minutes of blending, the hydrocolloid component is added slowly to the blender containing the amphoteric carrier and hydrophobic oil-dispersing agent mixtures. Optionally, a flow modifier is added to the mixture containing the amphoteric carrier, hydrophobic oil, dispersing agent and hydrocolloid component and mixed for 20 minutes.

This method of preparation of the edible moisture barrier composition produces a dry composition, which can be applied to a food product to minimize moisture migration as described herein below.

Application of Edible Moisture Barrier Composition to Food Product

Once the edible moisture barrier composition is prepared as described herein above, it can be applied to a food product. Advantageously, food products generally having multiple layers comprising (1) a baked flour-based system and (2) a water-based food composition benefit from application of the edible moisture barrier composition of the invention being applied between the layers. Exemplary food products wherein the edible moisture barrier composition is advantageous are pizzas, potpies, fruit or cream pies, glazed doughnuts, prepackaged cheese and crackers, prepackaged bagel and cream cheese, etc. Where minimization of moisture migration between adjacent portions of a food product having different water activities is desired, the edible moisture barrier composition is sprayed onto a first layer of the food product to minimize moisture migration from the first layer to a second layer of the food product. The water activities of the layers, preferably, have a difference of at least about 0.05; more preferably, a difference of at least about 0.08; even more preferably a difference of at least about 0.1 or more.

Alternately, where minimization of moisture migration between a food product and the ambient environment is desired, the edible moisture barrier composition of the invention is sprayed onto one or more outer surfaces of the food product. This application minimizes the change in quality of the product upon storage; particularly, it prevents freezer burn upon freezer storage. Also, this application allows for the preservation of food products, which primarily lose acceptable taste qualities by either losing moisture to or gaining moisture from the environment. For example, low moisture foods such as crackers generally absorb moisture from the environment and a moisture barrier composition of the invention slows the moisture absorption. Moreover, high moisture foods such as brownies and cookies usually lose moisture over time and application of a moisture barrier composition slows this moisture loss.

The thickness of the moisture barrier composition applied to a first layer of a food product is thick enough to provide an effective barrier to moisture migration between the first layer and a second layer of a food product, however, the moisture barrier layer is thin enough that the consumer cannot taste the moisture barrier composition upon consuming the food product. Accordingly, the thickness of the moisture barrier composition applied is from about 0.1 mm to about 0.8 mm thick. In another embodiment, the thickness of the moisture barrier composition is from about 0.1 mm to about 0.5 mm thick; from about 0.1 mm to about 0.3 mm thick; from about 0.1 mm to about 0.2 mm thick; preferably, from about 0.1 mm to about 0.15 mm thick.

What is claimed is:

1. An edible moisture barrier composition for minimizing moisture migration from a first layer to a second layer in a food product, the edible moisture barrier composition comprising:
an edible amphoteric carrier component capable of immobilizing the edible moisture barrier composition on either the first or the second layer, wherein the edible amphoteric carrier component is substantially soluble in water;
an edible hydrophobic component capable of coalescing at an application temperature; and
an edible dispersing agent capable of increasing the dispersal of the edible hydrophobic component in the edible amphoteric carrier component.

2. The edible moisture barrier composition of claim 1 wherein the edible amphoteric carrier component has a nitrogen solubility index from about 85% to about 90%.

3. The edible moisture barrier composition of claim 1 wherein the edible amphoteric carrier component is selected from the group consisting of soy protein, starches and combinations thereof.

4. The edible moisture barrier composition of claim 3 wherein the soy protein has an average particle diameter of from about 60 to about 80 microns.

5. The edible moisture barrier composition of claim 1 wherein the edible amphoteric carrier component is present in an amount from about 75% (by weight edible moisture barrier composition) to about 97% (by weight edible moisture barrier composition).

6. The edible moisture barrier composition of claim 1 wherein the edible hydrophobic component is selected from the group consisting of soybean oil, canola oil, peanut oil, and combinations thereof.

7. The edible moisture barrier composition of claim 6 wherein the edible hydrophobic component is present in an amount from about 2% (by weight edible moisture barrier composition) to about 4% (by weight edible moisture barrier composition).

8. The edible moisture barrier composition of claim 1 wherein the edible dispersing agent is selected from the group consisting of monoglycerides, diglycerides, lecithins, and combinations thereof.

9. The edible moisture barrier composition of claim 1 wherein the edible dispersing agent comprises soy lecithin.

10. The edible moisture barrier composition of claim 8 wherein the edible dispersing agent is present in an amount from about 0.2% (by weight edible moisture barrier composition) to about 0.4% (by weight edible moisture barrier composition).

11. The edible moisture barrier composition of claim 1 wherein the food product is a pizza; the edible amphoteric carrier component is a soy protein having a viscosity of at least about 200 centipoise measured at 10 wt. % solids and 60 rpm and is present in an amount from about 95% (by weight edible moisture barrier composition) to about 97% (by weight edible moisture barrier composition); the edible hydrophobic component is a soybean oil present in an amount from about 2% (by weight edible moisture barrier composition) to about 4% (by weight edible moisture barrier composition); and the edible dispersing agent is a soy lecithin present in an amount from about 0.2% (by weight edible moisture barrier composition) to about 0.4% (by weight edible moisture barrier composition).

12. The edible moisture barrier composition of claim 1 wherein the composition further comprises an edible hydrocolloid component capable of promoting the immobilization of the edible moisture barrier composition.

13. A food product comprising a first layer, a second layer, and an edible moisture barrier composition located between the first layer and second layer, the edible moisture barrier composition comprising:
an edible amphoteric carrier component capable of immobilizing the edible moisture barrier composition on either the first or second layer, wherein the edible amphoteric carrier component is substantially soluble in water;
an edible hydrophobic component capable of coalescing at an application temperature; and
an edible dispersing agent capable of increasing the dispersal of the edible hydrophobic component in the edible amphoteric carrier.

14. The food product of claim 13 wherein the edible hydrophobic component comprises soybean oil.

15. The food product of claim 13 wherein the edible amphoteric carrier component comprises a soy protein having a viscosity of at least about 200 centipoise measured at 10 wt. % solids and 60 rpm, the edible hydrophobic component comprises a soybean oil, and the edible dispersing agent comprises a soy lecithin.

16. The food product of claim 15 wherein soy protein having a viscosity of at least about 200 centipoise measured at 10 wt. % solids and 60 rpm is present in an amount of from about 75% (by weight edible moisture barrier composition) to about 97% (by weight edible moisture barrier composition), the soybean oil is present in an amount from about 1% (by weight edible moisture barrier composition) to about 5% (by weight edible moisture barrier composition), and the soy lecithin is present in an amount from about 0.1% (by weight edible moisture barrier composition) to about 0.9% (by weight edible moisture barrier composition).

17. The food product of claim 13 further comprising an edible hydrocolloid component capable of promoting the immobilization of the edible moisture barrier composition.

18. An edible moisture barrier composition for minimizing moisture migration from a first layer to a second layer in a food product comprising:
a soy protein component capable of immobilizing the edible moisture barrier composition on either the first or second layer, wherein the soy protein is substantially soluble in water;
a soybean oil component;
lecithin capable of increasing the dispersal of the soybean oil in the soy protein; and
a gum capable of promoting the immobilization of the edible moisture barrier composition.

19. The edible moisture barrier composition of claim 18 wherein soy protein is present in an amount of from about 75% (by weight edible moisture barrier composition) to about 98.5% (by weight edible moisture barrier composition); the soybean oil is present in an amount from about 1% (by weight edible moisture barrier composition) to about 9% (by weight edible moisture barrier composition), the lecithin is present in an amount from about 0.05% (by weight edible moisture barrier composition) to about 2.7% (by weight edible moisture barrier composition), and the gum is present in an amount from about 0.1% (by weight edible moisture barrier composition) to about 2% (by weight edible moisture barrier composition).

20. The edible moisture barrier composition of claim 18 wherein soy protein is present in an amount of from about 75% (by weight edible moisture barrier composition) to about 97% (by weight edible moisture barrier composition); the soybean oil is present in an amount from about 1% (by weight edible moisture barrier composition) to about 5% (by weight edible moisture barrier composition); the lecithin is present in an amount from about 0.1% (by weight edible moisture barrier composition) to about 0.9% (by weight edible moisture barrier composition); and the gum is present in an amount from about 0.1% (by weight edible moisture barrier composition) to about 0.5% (by weight edible moisture barrier composition).

21. The edible moisture barrier composition of claim 18 wherein soy protein is present in an amount of from about 95% (by weight edible moisture barrier composition) to about 97% (by weight edible moisture barrier composition); the soybean oil is present in an amount from about 2% (by weight edible moisture barrier composition) to about 4% (by weight edible moisture barrier composition); the lecithin is present in an amount from about 0.2% (by weight edible moisture barrier composition) to about 0.4% (by weight edible moisture barrier composition); and the gum is present in an amount from about 0.1% (by weight edible moisture barrier composition) to about 0.2% (by weight edible moisture barrier composition).
